(19) United States
(12) Patent Application Publication
(10) Pub. No.: US 2025/0385733 A1
(43) Pub. Date: Dec. 18, 2025

(54) MONITORING DEVICE, MONITORING METHOD, AND MONITORING PROGRAM

(71) Applicant: NIPPON TELEGRAPH AND TELEPHONE CORPORATION, Tokyo (JP)

(72) Inventors: Takuya MINAMI, Tokyo (JP); Takaaki KOYAMA, Tokyo (JP)

(73) Assignee: NIPPON TELEGRAPH AND TELEPHONE CORPORATION, Tokyo (JP)

(21) Appl. No.: 18/877,214

(22) PCT Filed: Jun. 21, 2022
(86) PCT No.: PCT/JP2022/024760

§ 371 Date: Dec. 19, 2024

(51) Int. Cl. H04B 10/07; H04B 10/25

(52) U.S. Cl. CPC H04B 10/07; H04B 10/25

(57) ABSTRACT

A monitoring device (100) includes an acquisition unit (121), a first creation unit (122), a second creation unit (125), and an identification unit (126). The acquisition unit (121) acquires terminal accommodation information, configuration information, and information regarding terminals. The first creation unit (122) creates information on paths used for communication of the terminals and information on a terminal group in communication sections of the terminals on the basis of the terminal accommodation information and configuration information acquired by the acquisition unit (121). The second creation unit (125) creates information on a change in each terminal on the basis of the information regarding the terminals acquired by the acquisition unit (121). The identification unit (126) identifies an abnormal communication section on the basis of the information on the paths used for communication of the terminals and the information on the terminal group in the communication sections of the terminals, created by the first creation unit (122), and the information on a change in each terminal, created by the second creation unit (125).

### TECHNICAL FIELD

The present invention relates to a monitoring device, a monitoring method, and a monitoring program.

### BACKGROUND ART

Conventionally, there is a communication system having a communication line in which communication paths are multiplexed and accommodated between terminals, such as an optical fiber. Further, a measuring instrument for optical communication called an optical time domain reflectometer (OTDR) is used to detect a breaking point of an optical fiber.

### CITATION LIST

### Non Patent Literature

Non Patent Literature 1: OTDR, TechEyesOnline Keisokukannrennyougoshu (in Japanese) (TechEyesOnline measurement related terminology) (https://www.techeyesonline.com/glossary/detail/OTDR/)
Non Patent Literature 2: T. Tanaka, T. Inui, S. Kawai, S. Kuwabara and H. Nishizawa, “Monitoring and diagnostic technologies using deep neural networks for predictive optical network maintenance [Invited],” in Journal of Optical Communications and Networking, vol. 13, no. 10, pp. E13-E22, October 2021, doi: 10.1364/JOCN.424428. (https://ieeexplore.ieee.org/document/9439443)

### SUMMARY OF INVENTION

### Technical Problem

However, the conventional techniques have a problem that it is difficult to identify an abnormal communication section before occurrence of an abnormality and a handling cost is high. For example, in an optical communication system, after an abnormality has occurred, a maintenance responder who has received an alert from a device or a report from a user needs to carry an OTDR and perform an operation of identifying an abnormality occurrence section. As described above, problems to be solved by the present invention include, as an example, a problem that it is difficult to identify an abnormal communication section before occurrence of an abnormality and a handling cost is high.

### Solution to Problem

In order to solve the above-described problems and achieve the object, a monitoring device according to the present invention includes an acquisition unit, a first creation unit, a second creation unit, and an identification unit. The acquisition unit acquires terminal accommodation information, configuration information, and information regarding terminals. The first creation unit creates information on paths used for communication of the terminals and information on a terminal group in communication sections of the terminals on the basis of the terminal accommodation information and configuration information acquired by the acquisition unit. The second creation unit creates information on a change in each terminal on the basis of the information regarding the terminals acquired by the acquisition unit. The identification unit identifies an abnormal communication section on the basis of the information on the paths used for communication of the terminals and the information on the terminal group in the communication sections of the terminals, created by the first creation unit, and the information on a change in each terminal, created by the second creation unit.

### Advantageous Effects of Invention

According to the present invention, it is possible to facilitate identification of an abnormal communication section before occurrence of an abnormality and reduce a handling cost.

### BRIEF DESCRIPTION OF DRAWINGS

FIG. 1 is a block diagram showing an example of a configuration of a monitoring device according to an embodiment.

FIG. 2 is a diagram illustrating an overview of the monitoring device according to the embodiment.

FIG. 3 is a diagram showing an example of table creation processing of the monitoring device according to the embodiment.

FIG. 4 is a diagram showing an example of table creation processing of the monitoring device according to the embodiment.

FIG. 5 is a diagram showing an example of table creation processing of the monitoring device according to the embodiment.

FIG. 6 is a flowchart showing an example of a flow of identification processing of the monitoring device according to the embodiment.

FIG. 7 is a diagram showing an example of a computer that executes a monitoring program.

### DESCRIPTION OF EMBODIMENTS

Hereinafter, embodiments of a monitoring device, a monitoring method, and a monitoring program according to the present application will be described in detail with reference to the drawings. Note that the present invention is not limited by the embodiment. In addition, in the description of the drawings, the same parts are denoted by the same reference numeral, and redundant description is omitted.

### [Configuration of Monitoring Device]

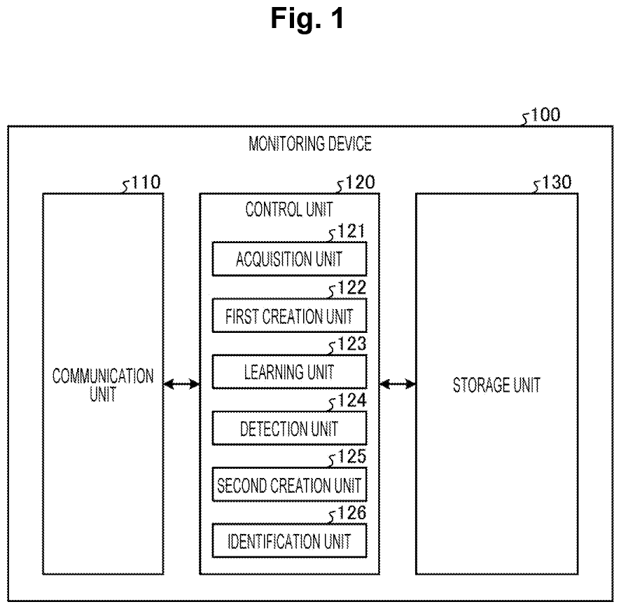

First, a configuration of a monitoring device 100 will be described with reference to FIG. 1. FIG. 1 is a diagram showing an example of a configuration of the monitoring device 100 according to an embodiment. As shown in FIG. 1, the monitoring device 100 includes a communication unit 110, a control unit 120, and a storage unit 130. Note that a plurality of devices may hold these units in a distributed manner. Hereinafter, processing of each of these units will be described.

The communication unit 110 is realized by a network interface card (NIC) or the like and enables communication between the control unit 120 and an external device via an electrical communication line such as a local area network (LAN) or the Internet. For example, the communication unit 110 enables communication between an external device and the control unit 120.

The storage unit 130 is realized by a semiconductor memory element such as a random access memory (RAM) or a flash memory, or a storage device such as a hard disk or an optical disc. Information stored in the storage unit 130 includes, for example, terminal accommodation information, configuration information, information regarding terminals, data regarding a machine learning algorithm, a trained model, other information necessary to identify an abnormal communication section, and the like. Note that the information stored in the storage unit 130 is not limited to the information described above.

The control unit 120 is realized by using a central processing unit (CPU), a network processor (NP), a field programmable gate array (FPGA), or the like, and executes a processing program stored in a memory. As shown in FIG. 1, the control unit 120 includes an acquisition unit 121, a first creation unit 122, a learning unit 123, a detection unit 124, a second creation unit 125, and an identification unit 126. Hereinafter, each unit included in the control unit 120 will be described.

The acquisition unit 121 acquires terminal accommodation information, configuration information, and information regarding terminals. For example, the acquisition unit 121 acquires information on terminals included in a predetermined section as terminal accommodation information. In addition, for example, the acquisition unit 121 acquires information on communication paths as terminal configuration information. Further, for example, the acquisition unit 121 acquires information on received light power values of the terminals as information regarding the terminals.

The first creation unit 122 creates information on paths used for communication of the terminals and information on a terminal group in communication sections of the terminals on the basis of the terminal accommodation information and configuration information acquired by the acquisition unit 121. For example, the first creation unit 122 creates a table including the information on the paths used for communication of the terminals and the information on the terminal group in the communication sections of the terminals on the basis of the terminal accommodation information and configuration information acquired by the acquisition unit 121.

The learning unit 123 learns states of the terminals on the basis of the information regarding the terminals acquired by the acquisition unit 121. For example, the learning unit 123 learns normal states of the terminals on the basis of the information regarding the terminals acquired by the acquisition unit 121. Further, in the case of an optical communication system, for example, the learning unit 123 learns the normal states of the terminals by using received light power and a value correlated with the received light power acquired by the acquisition unit 121. Here, the learning unit 123 may learn the normal states of the terminals using information input by a person, acquired by the acquisition unit 121, or may learn the normal states of the terminals according to machine learning.

The detection unit 124 detects changes with respect to the states of the terminals learned by the learning unit 123. For example, the detection unit 124 detects changes with respect to the normal states of the terminals learned by the learning unit 123. Further, for example, the detection unit 124 detects a change toward abnormality with respect to a normal state of a terminal learned by the learning unit 123.

The second creation unit 125 creates information on a change in each terminal on the basis of the information regarding the terminals acquired by the acquisition unit 121. For example, the second creation unit 125 creates a table including information on a change in each terminal on the basis of the information regarding the terminals acquired by the acquisition unit 121. Further, for example, the second creation unit 125 creates information on a change in each terminal on the basis of changes with respect to the states of the terminals detected by the detection unit 124.

The identification unit 126 identifies an abnormal communication section on the basis of the information on the paths used for communication of the terminals and the information on the terminal group in the communication sections of the terminals, created by the first creation unit 122, and the information on a change in each terminal, created by the second creation unit 125. For example, the identification unit 126 identifies an abnormal communication section by comparing the information on the paths used for communication of the terminals and the information on the terminal group in the communication sections of the terminals, created by the first creation unit 122, with the information on a change in each terminal, created by the second creation unit 125.

More specifically, the identification unit 126 compares a table including the information on the paths used for communication of the terminals and the information on the terminal group in the communication sections of the terminals, created by the first creation unit 122, with a table including the information on a change in each terminal, created by the second creation unit 125, and in a case where there is a row having matching values, identifies a communication section indicated by the row as an abnormal communication section. Note that an abnormal communication section includes a communication section in which a sign of abnormality occurs in addition to a communication section in which an abnormality occurs.

### [Overview of Processing Performed by Monitoring Device]

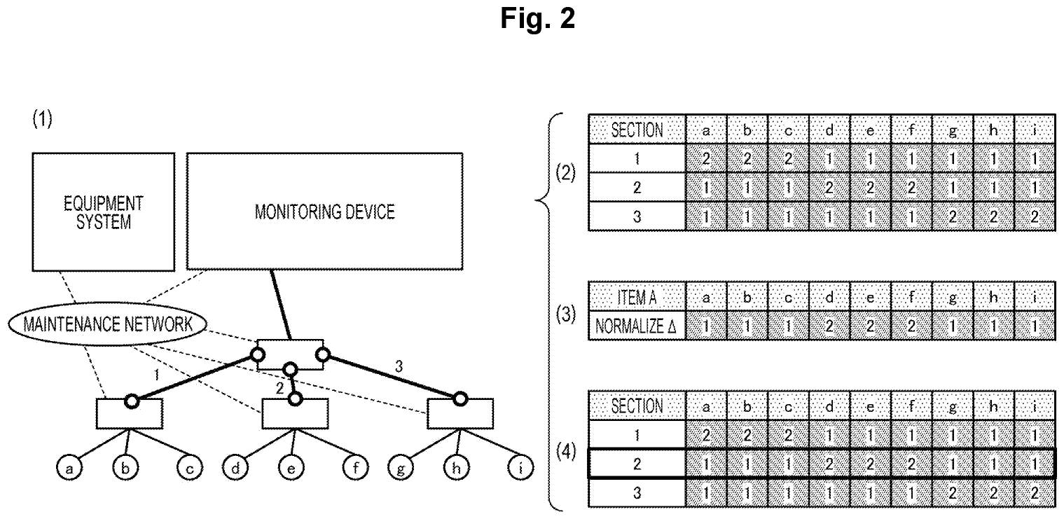

Next, an example of processing performed by the monitoring device 100 according to the embodiment will be described using FIG. 2. FIG. 2 is a diagram for describing an overview of processing performed by the monitoring device 100 according to the embodiment.

First, FIG. 2(1) illustrates a monitoring system including the monitoring device 100. Next, FIG. 2(2) is a table including information on paths used for communication of terminals and information on a terminal group in communication sections of the terminals, created by the first creation unit 122. FIG. 2(3) is a table including information on a change in each terminal, created by the second creation unit 125.

Then, the identification unit 126 compares the table including the information on the paths used for communication of the terminals and the information on the terminal group in the communication sections of the terminals in FIG. 2(2) with the table including the information on a change in each terminal in FIG. 2(3), thereby identifying an abnormal communication section such as section 2 surrounded by a thick frame in FIG. 2(4). For example, the identification unit 126 compares values of the table including the information on a change in each terminal in FIG. 2(3) with values of the table including the information on the paths used for communication of the terminals and the information on the terminal group in the communication sections of the terminals in FIG. 2(2), and determines whether there is a row having matching values. Then, when there is a row having matching values, the identification unit 126 identifies a communication section indicated by the row as an abnormal communication section.

In a case where the value changes only in a specific terminal in the table including the information on a change in each terminal, and there is no row having matching values in comparison with the table including the information on the paths used for communication of the terminals and the information on the terminal group in the communication sections of the terminals, an abnormality of the specific terminal is suspected instead of an abnormality in a communication section.

### [Processing of Creating Table Including Information on Paths Used for Communication of Terminals and Information on Terminal Group in Communication Sections of Terminals]

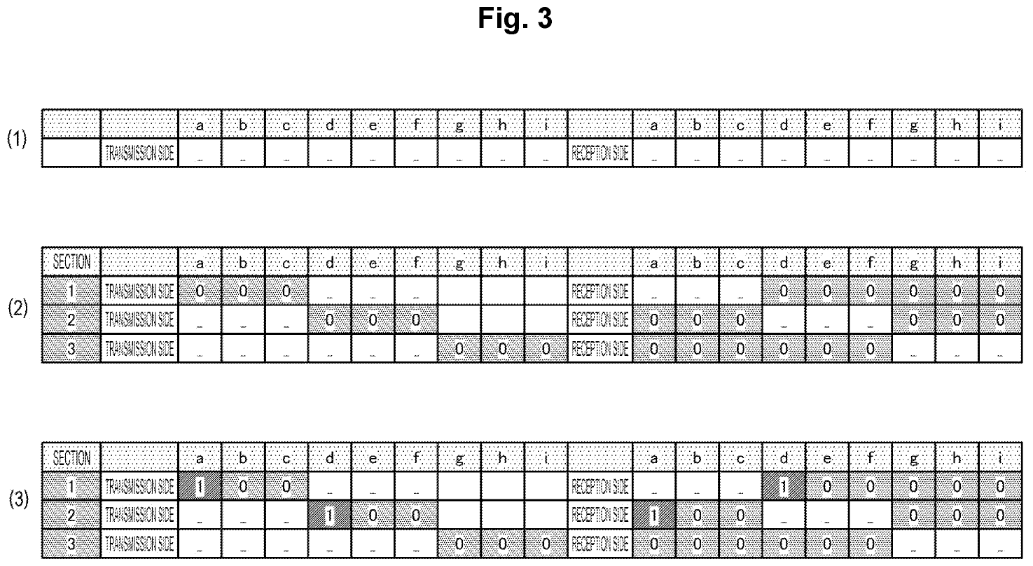

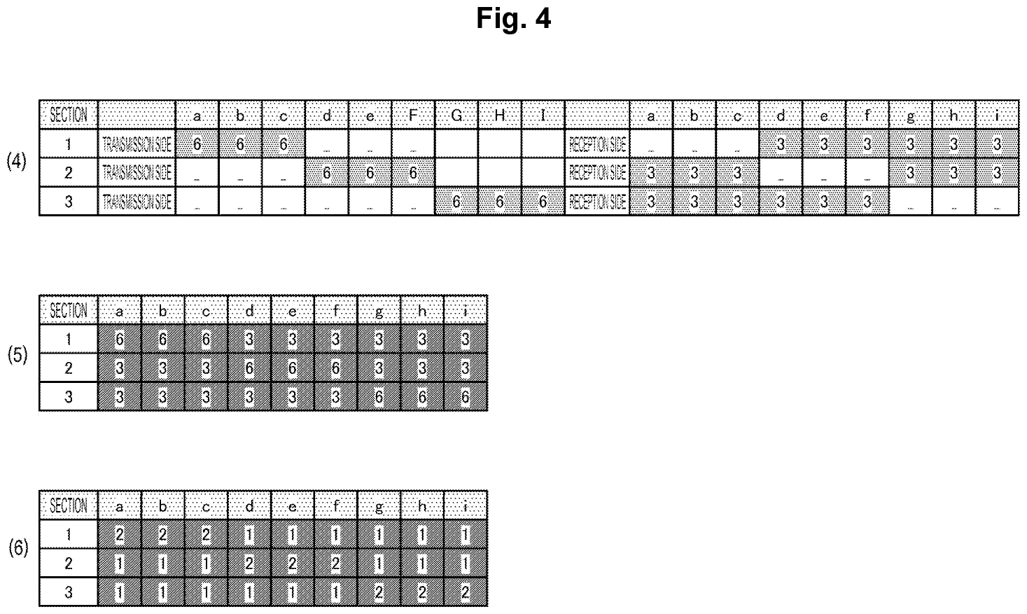

Next, an example of processing of creating a table including information on paths used for communication of terminals and information on a terminal group in communication sections of the terminals according to an embodiment will be described using FIGS. 3 and 4. FIGS. 3 and 4 are diagrams for describing processing of creating a table including information on paths used for communication of terminals and information on a terminal group in communication sections of the terminals according to the embodiment. FIGS. 3(1) to 3(3) and FIGS. 4(4) to 4(6) are tables in which communication sections and terminals are written. In each table, a row represents a communication section, and a column represents each terminal.

First, FIG. 3(1) is an array created by the first creation unit 122 and having elements corresponding to the total number of terminals on each of a transmission side and a reception side. Next, the first creation unit 122 inputs 0 to elements of the terminals present in each communication section (FIG. 3(2)). Then, in a case where there is a path for communication via a section between terminals, the first creation unit 122 adds 1 to the corresponding position (FIG. 3(3)). For example, in a case where there is a path between a terminal a on the transmission side and a terminal d on the reception side, the first creation unit 122 adds 1 to each of the element of the terminal a on the transmission side and the element of the terminal d on the reception side.

The first creation unit 122 repeats processing of FIG. 3(3) for all paths for communication between terminals via the sections (FIG. 4(4)). Then, the first creation unit 122 combines the reception side parts and the transmission side parts (FIG. 4(5)). Then, the first creation unit 122 normalizes the combined table by dividing the element in each row by the minimum value of the rows for each section (FIG. 4(6)), and creates a table including information on the paths used for communication of the terminals and information on the terminal group in the communication sections of the terminals.

### [Processing of Creating Table Including Information on Changes]

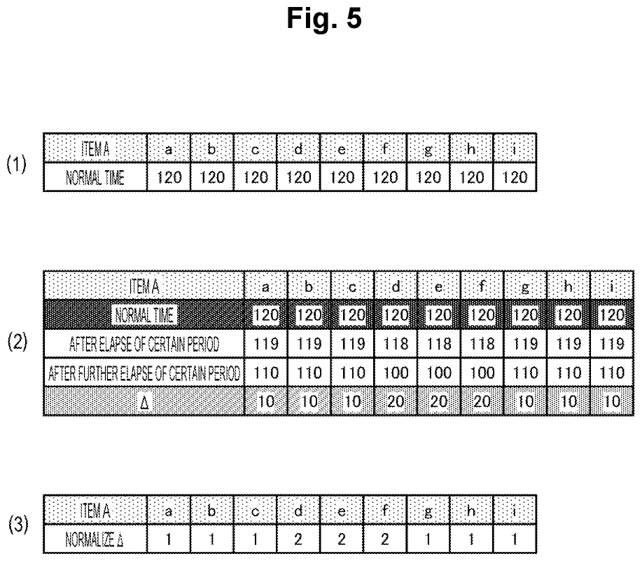

Next, an example of processing of creating a table including information on changes in the monitoring device according to the embodiment will be described using FIG. 5. FIG. 5 is a diagram for describing processing of creating a table including information on changes in the monitoring device according to the embodiment.

FIG. 5(1) is a diagram showing, in a tabular form, a value at a normal time in each terminal acquired by the acquisition unit 121. Here, the learning unit 123 learns a state at the normal time in each terminal using information acquired by the acquisition unit 121 as an input. For example, the learning unit 123 learns regularity such as a correlation between input values acquired by the acquisition unit 121 according to input from a person or machine learning.

Next, the detection unit 124 detects changes with respect to states at the normal time with the elapse of time (FIG. 5(2)). At this time, the detection unit 124 represents a change amount from a state at the normal time by A. Then, the second creation unit 125 normalizes the change amount 4 by dividing the element in each row by the minimum value in the rows using the change amount A detected by the detection unit 124(FIG. 5(3)), and creates a table including information on changes.

### [Flowchart]

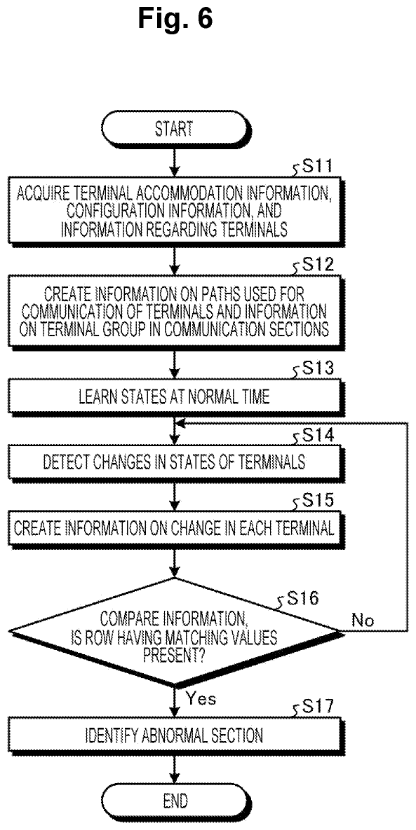

Next, a flow of monitoring processing performed by the monitoring device 100 will be described using FIG. 6. FIG. 6 is a flowchart showing an example of a flow of monitoring processing according to the present embodiment.

First, the acquisition unit 121 acquires terminal accommodation information, configuration information, and information regarding terminals (step S11). For example, the acquisition unit 121 acquires information on terminals included in a predetermined section as terminal accommodation information. In addition, for example, the acquisition unit 121 acquires information on communication paths as terminal configuration information.

Next, the first creation unit 122 creates information on paths used for communication of terminals and information on a terminal group in communication sections of the terminals on the basis of the terminal accommodation information and configuration information acquired by the acquisition unit 121 (step S12). For example, the first creation unit 122 creates a table including the information on the paths used for communication of the terminals and the information on the terminal group in the communication sections of the terminals on the basis of the terminal accommodation information and configuration information acquired by the acquisition unit 121.

Then, the learning unit 123 learns states of the terminals on the basis of the information regarding the terminals acquired by the acquisition unit 121 (step S13). For example, the learning unit 123 learns normal states of the terminals on the basis of the information regarding the terminals acquired by the acquisition unit 121. Further, in an optical communication system, for example, the learning unit 123 learns the normal states of the terminals using received light power and values correlated with the received light power acquired by the acquisition unit 121.

Then, the detection unit 124 detects changes with respect to the states of the terminals learned by the learning unit 123 (step S14). For example, the detection unit 124 detects changes with respect to the normal states of the terminals learned by the learning unit 123. Further, for example, the detection unit 124 detects changes toward abnormality as changes with respect to the normal states of the terminals learned by the learning unit 123.

Then, the second creation unit 125 creates information on a change in each terminal on the basis of the information regarding the terminals acquired by the acquisition unit 121 (step S15). For example, the second creation unit 125 creates information on a change in each terminal on the basis of changes with respect to the normal states of the terminals detected by the detection unit 124.

Then, the identification unit 126 compares a table including the information on the paths used for communication of the terminals and the information on the terminal group in the communication sections of the terminals, created by the first creation unit 122, with a table including the information on a change in each terminal, created by the second creation unit 125, and determines whether there is a row having matching values (step S16). Here, in a case where there is no row having matching values (“NO” in step S16), the detection unit 124 re-detects changes in the states of the terminals (step S14).

On the other hand, in a case where there is a row having matching values (“YES” in step S16), the identification unit 126 identifies an abnormal communication section on the basis of the information on paths used for communication of the terminals and the information on the terminal group in the communication sections of the terminals created by the first creation unit 122, and the information on a change in each terminal created by the second creation unit 125 (step S17). For example, the identification unit 126 compares the table including the information on the paths used for communication of the terminals and the information on the terminal group in the communication sections of the terminals created by the first creation unit 122 with the table including the information on a change in each terminal created by the second creation unit 125, and identifies a communication section indicated by a row having matching values as an abnormal communication section.

### Effects

As described above, the monitoring device 100 according to the embodiment includes the acquisition unit 121, the first creation unit 122, the second creation unit 125, and the identification unit 126. The acquisition unit 121 acquires terminal accommodation information, configuration information, and information regarding terminals. The first creation unit 122 creates information on paths used for communication of the terminals and information on a terminal group in communication sections of the terminals on the basis of the terminal accommodation information and configuration information acquired by the acquisition unit 121. The second creation unit 125 creates information on a change in each terminal on the basis of the information regarding the terminals acquired by the acquisition unit 121. The identification unit 126 identifies an abnormal communication section on the basis of the information on the paths used for communication of the terminals and the information on the terminal group in the communication sections of the terminals, created by the first creation unit 122, and the information on a change in each terminal, created by the second creation unit 125.

As a result, the monitoring device 100 according to the embodiment can identify an abnormal communication section due to optical fiber breakage or the like without using a device such as an OTDR in an optical communication system by using the information on the paths used for communication of the terminals, the information on the terminal group, and the information on a change in each terminal. As a result, the monitoring device 100 according to the embodiment analyzes an insignificant change occurring in each terminal and the tendency thereof, and thus it is not necessary to acquire information such as a device log and an alert, and it is possible to identify an abnormal communication section at the stage of an abnormality sign before occurrence of the abnormality and reduce the cost for handling the occurrence of the abnormality.

That is, the monitoring device 100 according to the embodiment can identify an abnormal communication section through calculation processing using software without using a dedicated diagnostic device in a communication system having a communication line in which communication paths are multiplexed and accommodated between terminals, such as an optical fiber.

In addition, the monitoring device 100 according to the embodiment further includes the learning unit 123 that learns normal states of terminals on the basis of the information regarding terminals acquired by the acquisition unit 121, and the detection unit 124 that detects changes with respect to the normal states of the terminals learned by the learning unit 123, and the second creation unit 125 in the monitoring device 100 creates information on a change in each terminal on the basis of the changes with respect to the states of the terminals detected by the detection unit 124. With this configuration, the monitoring device 100 can identify an abnormal communication section at the stage of an abnormality sign before occurrence of the abnormality by learning the state of each terminal and detecting a change from the learned state of the terminal.

Furthermore, in the monitoring device 100 according to the embodiment, the learning unit 123 learns normal states of terminals on the basis of the information regarding the terminals acquired by the acquisition unit 121, and the detection unit 124 detects changes with respect to the normal states of the terminals learned by the learning unit 123. With this configuration, the monitoring device 100 can identify an abnormal communication section at the stage of an abnormality sign before occurrence of the abnormality by learning the normal state of each terminal and detecting a change from a learned normal state of a terminal.

In addition, in the monitoring device 100 according to the embodiment, the detection unit 124 detects a change toward an abnormality as a change with respect to a learned normal state of a terminal. With this configuration, the monitoring device 100 can identify an abnormal communication section at the stage of an abnormality sign before occurrence of the abnormality by detecting a change toward an abnormality from a learned normal state of a terminal.

### [Program]

It is also possible to create a program in which processing executed by the monitoring device 100 described in the above embodiment is written in a language executable by a computer. In this case, when the computer executes the program, the same effects as those of the above embodiment can be obtained. Further, such a program may be recorded in a computer-readable recording medium, and the program recorded in the recording medium may be read and executed by a computer to realize processing similar to the above-described embodiment.

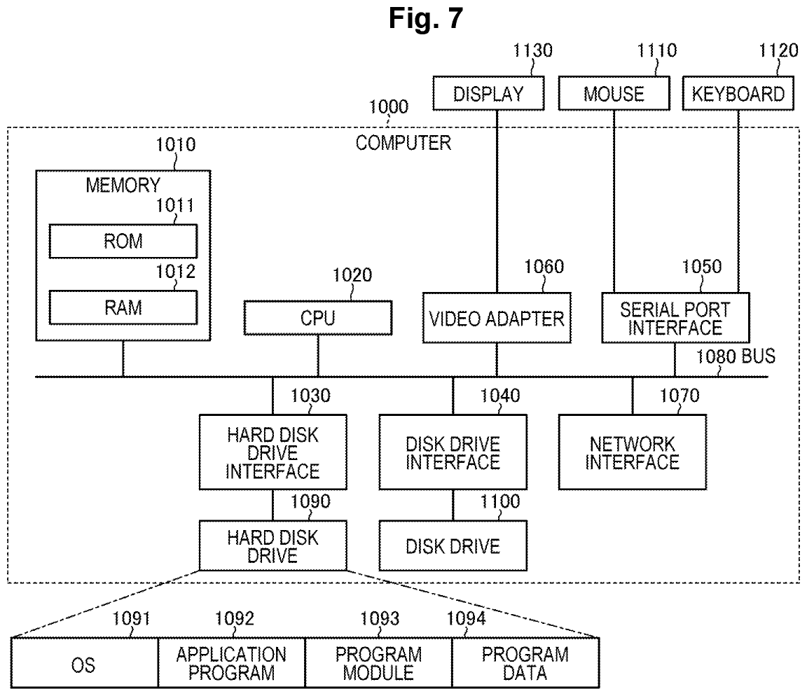

FIG. 7 is a diagram showing an example of a computer that executes a monitoring program. As shown in FIG. 7, the computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to the hard disk drive 1090. The disk drive interface 1040 is connected to the disk drive 1100. For example, a removable storage medium such as a magnetic disk or an optical disk is inserted into the disk drive 1100. For example, a mouse 1110 and a keyboard 1120 are connected to the serial port interface 1050. For example, a display 1130 is connected to the video adapter 1060.

Here, as shown in FIG. 7, the hard disk drive 1090 stores, for example, an OS 1091, an application program 1092, a program module 1093, and program data 1094. Each table described in the above embodiment is stored in, for example, the hard disk drive 1090 or the memory 1010.

In addition, the monitoring program is stored in the hard disk drive 1090 as, for example, a program module in which commands executed by the computer 1000 are written. Specifically, the program module 1093 in which each kind of processing executed by the computer 1000 described in the above embodiment is written is stored in the hard disk drive 1090.

In addition, data used for information processing by the monitoring program is stored, for example, in the hard disk drive 1090 as program data. Then, the CPU 1020 reads the program module 1093 and the program data 1094 stored in the hard disk drive 1090 to the RAM 1012 as necessary and executes each procedure described above.

Note that the program module 1093 and the program data 1094 related to the monitoring program are not limited to being stored in the hard disk drive 1090, and may be stored in, for example, a detachable storage medium and read by the CPU 1020 via the disk drive 1100 or the like. Alternatively, the program module 1093 and the program data 1094 related to the control program may be stored in another computer connected via a network such as a local area network (LAN) or a wide area network (WAN) and read by the CPU 1020 via the network interface 1070.

### [Others]

Although various embodiments have been described herein in detail with reference to the drawings, these multiple embodiments are examples and are not intended to limit the invention to these multiple embodiments. The features described herein may be realized by various methods, including various modifications and improvements based on the knowledge of those skilled in the art.

In addition, the “unit (module, -er suffix, or -or suffix)” described above can be read as a unit, a means, a circuit, or the like. For example, a communication module, a control module, and a storage module can be replaced with a communication unit, a control unit, and a storage unit, respectively.

### REFERENCE SIGNS LIST

100 Monitoring device
110 Communication unit
120 Control unit
121 Acquisition unit
122 First creation unit
123 Learning unit
124 Detection unit
125 Second creation unit
126 Identification unit
130 Storage unit

1. A monitoring device comprising a processor configured to execute operations comprising:
acquiring terminal accommodation information, configuration information, and terminal information of a terminal;
creating path information on paths used for communication of the terminal and terminal group information on a terminal group in communication sections of the terminal on the basis of the terminal accommodation information and the configuration information;
creating change information on a change in the terminal on the basis of the terminal information of the terminal; and
identifying an abnormal communication section on the basis of the path information, the terminal group information, and the change information.

2. The monitoring device according to claim 1, further comprising:
learning a state of the terminal on the basis of the terminal information; and
detecting a changes of the learnt state of the terminal,
wherein the creating the change information further comprises creating the change information of the terminal on the basis of the detected change of the state of the terminal.

3. The monitoring device according to claim 2, wherein
the learning further comprises learning normal states of terminal on the basis of the terminal information, and
the detecting further comprises detecting a change from the learnt normal states of the terminal.

4. The monitoring device according to claim 3, wherein the detecting further comprises detecting a change toward an abnormality as a change with respect to a learned normal state of the terminal.

5. A method of monitoring, comprising:
acquiring terminal accommodation information, configuration information, and terminal information regarding a terminal;
creating path information on paths used for communication of the terminal and terminal group information on a terminal group in communication sections of the terminal on the basis of the terminal accommodation information and the configuration information;
creating change information on a change in the terminal on the basis of the terminal information of the terminal; and
identifying an abnormal communication section on the basis of the path information, the terminal group information, and the change information.

6. A computer-readable non-transitory recording medium storing a computer-executable program instructions that when executed by a processor cause a computer to execute operations comprising:
acquiring terminal accommodation information, configuration information, and terminal information regarding a terminal;
creating path information on paths used for communication of the terminal and terminal group information on a terminal group in communication sections of the terminal on the basis of the terminal accommodation information and the configuration information;
creating change information on a change in the terminal on the basis of the terminal information of the terminal; and
identifying an abnormal communication section on the basis of the path information, the terminal group information, and the change information.

7. The monitoring device according to claim 1, wherein the communication sections comprise an optical fiber.

8. The monitoring device according to claim 1, wherein the abnormal communication section comprises an optical fiber.

9. The monitoring device according to claim 1, wherein the identifying the abnormal communication section further comprises detecting an optical fiber breakage in the abnormal communication section without using an optical time domain reflectometer.

10. The monitoring device according to claim 1, wherein the identifying the abnormal communication section further comprises identifying a communication section of the communication sections as the abnormal communication section when the change information indicates no change.
